(19) United States
(12) Patent Application Publication
(10) Pub. No.: US 2015/0193459 A1
(43) Pub. Date: Jul. 9, 2015

(54) DATA FILE SEARCHING METHOD

(71) Applicant: 2020CyberSec Ltd, Surrey (GB)

(72) Inventor: Dave DUKE, Corby (GB)

(21) Appl. No.: 14/590,403

(22) Filed: Jan. 6, 2015

(30) Foreign Application Priority Data
Jan. 7, 2014 (GB) 1400191.1

(51) Int. Cl. G06F 17/30

(52) U.S. Cl. CPC G06F 17/30109; G06F 17/30097

(57) ABSTRACT

We describe a method of searching data in a data file in a storage device connected to a computer, the method comprising: maintaining the data file in a first database in the storage device, wherein the data file comprises at least one text entry, each text entry comprising an alphabetical word and at least one character; storing a copy of only the alphabetical word of each text entry in a second database in the storage device; associating a unique reference code with the copy of the alphabetical word of each text entry in the second database; creating a record of the associated unique reference code in the first database; associating the record of the associated unique reference code in the first database with the corresponding text entry of the data file maintained in the first database; and performing search of a search string entered by a user by using the copy of the alphabetical word of each text entry in the second database and by using the associated unique reference code in the second database and the record of the associated unique reference code in the first database to identify results of the search of the search string.

### FIELD OF THE INVENTION

The present invention relates to a method and system for searching data in a data file or a memory file, particularly but not exclusively, in a log file.

### BACKGROUND TO THE INVENTION

In information technology (IT) log files are generally very important. When a software application is running on an operating system, various events associated with the software application are generally captured in a log file. When data analysis is done on the operating system, the log file can be searched to facilitate the data analysis.

It is known that a search in a log file having a huge volume of data can take a significant amount of time. It is an aim of the present invention to address this problem.

### SUMMARY OF THE INVENTION

In accordance with one aspect of the present invention there is provided a method of searching data in a data file in a storage device connected to a computer, the method comprising: maintaining the data file in a first database in the storage device, wherein the data file comprises at least one text entry, each text entry comprising at least one alphabetical character, wherein a first unique reference code is associated with each text entry in the first database; storing a copy of the at least one alphabetical character of each text entry in a second database in the storage device; associating a second unique reference code with the copy of the at least one alphabetical character of each text entry in the second database; updating each text entry in the first database by associating the first unique reference code used in the first database with the second unique reference code used in the second database, and performing search of a search string entered by a user by using the copy of the at least one alphabetical character of each text entry in the second database and by using the second unique reference code in the second database and the first reference code in the first database to identify a text entry in the first database as a result of the search of the search string.

In one embodiment, there may be provided a method of searching data in a data file, the method comprising: maintaining the data file in a first database in the storage device, wherein the data file comprises at least one text entry, each text entry comprising an alphabetical word and at least one non-alphabetical character; storing a copy of only the alphabetical word of each text entry in a second database in the storage device; associating a unique reference code with the copy of the alphabetical word of each text entry in the second database; creating a record of the associated unique reference code in the first database; associating the record of the associated unique reference code in the first database with the corresponding text entry of the data file maintained in the first database; and performing search of a search string entered by a user by using the copy of the alphabetical word of each text entry in the second database and by using the associated unique reference code in the second database and the record of the associated unique reference code in the first database to identify results of the search of the search string.

It would be appreciated that the alphabetical characters include alphabetical words, space and/or tabs.

The invention significantly reduces the search time in a log file. Generally a log file can have, for example, millions of data entries. If a search is conducted through the very high volume of data entries, it will take a significant amount of time. The present invention solves this problem by creating the second anomaly database in which only an alphabetical portion of a data entry is stored. Then the search is conducted by searching initially in the second anomaly database in which significantly less amount of data are stored. Therefore it takes a very short time to find out a matched entry from the entries in the second database. The invention also employs a unique reference code associated to each data entry in the second database and then employs a record (copy) of the unique reference code in the first database. The record of the unique reference code in the first database can link the original data entry to the corresponding with the data entry in the second database. Therefore when the matched data entry having only the alphabetical word is found in the second database, the original data entry having both alphabetical and character portions can be found using the unique reference codes. Thus a filtered amount of data entry can be identified in the first database. Then the original search string is compared with the filtered amount of data entries in the first database to find the ultimate search results. In this way there is no need to search through all the data entries and therefore the search time can be short.

Each text entry in the first database further may comprise at least one non-alphabetical character. It would be appreciated that the non-alphabetical characters include signs, numbers, or symbols.

The step of storing the copy of the alphabetical character in the second database may comprise: applying an elimination code to a copy of each text entry in the first database to eliminate the at least one non-alphabetical character in each text entry so that only the at least one alphabetical character is remained in the copy of each text entry, and storing the remained at least one alphabetical character from the copy of each text entry in the second database.

The step of performing the search of the search string may comprise storing the search string entered by the user comprising at least one alphabetical character; comparing the at least one alphabetical character in the search string with the copy of the at least one alphabetical character of each text entry in the second database, and if a match is found, identifying the matched copy of the alphabetical word in the second database and using the second unique reference code associated with the matched copy of the alphabetical word in the second database and the associated first unique reference code in the first database to identify the associated text entry maintained by the data file in the first database, wherein the at least one alphabetical character in the search string can be found in the identified associated text entry.

The step of performing the search of the search string may comprise: storing the search string entered by the user, the search string comprising at least one alphabetical character and at least one non-alphabetical character; comparing only a copy of the at least one alphabetical character in the search string with the copy of the at least one alphabetical character of each text entry in the second database, if a match is found, identifying the matched copy of the alphabetical character in the second database and using the second unique reference code associated with the matched alphabetical character in the second database and the associated first unique reference code in the first database to identify the associated text entry maintained by the data file in the first database, comparing the at least one non-alphabetical character in the search string with the at least one non-alphabetical character of the identified associated text entry maintained by the data file in the first database, and if a match is found between the at least one non-alphabetical character in the search string and the at least one non-alphabetical character of the identified associated text entry, displaying the identified associated text entry in the first database as a result of the search of the search string.

The method may further comprise prior to comparing only the copy of the at least one alphabetical character in the search string, applying an elimination code to a copy of the search string to eliminate the at least one non-alphabetical character from the copy of the search string.

The method may further comprise prior to comparing the at least one alphabetical character in the search string with the copy of the alphabetical character of each text entry in the second database, converting each character in the search string to a lower case character.

The search string may further comprise at least two alphabetical words which are sorted in an alphabetical order before being compared with the copy of the alphabetical word of each text entry in the second database.

The data file may be a log file.

The first and second unique reference codes may be hash codes generated by a hash function. The at least one non-alphabetical character may be any one or more of a symbol, a sign and a digit.

According to a further aspect of the present invention, there is provided a system for searching data in a data file, the system comprising a server comprising processor control code to: to maintain the data file in a first database in the storage device, wherein the data file comprises at least one text entry, each text entry comprising at least one alphabetical character, wherein a first unique reference code is associated with each text entry in the first database; to store a copy of the at least one alphabetical character of each text entry in a second database in the storage device; to associate a second unique reference code with the copy of the at least one alphabetical character of each text entry in the second database; to update each text entry in the first database by associating the first unique reference code used in the first database with the second unique reference code used in the second database, and to perform search of a search string entered by a user by using the copy of the at least one alphabetical character of each text entry in the second database and by using the second unique reference code in the second database and the first reference code in the first database to identify a text entry in the first database as a result of the search of the search string.

In one embodiment, there may be provided a system for searching data in a data file, the system comprising a server comprising processor control code to: maintain the data file in a first database, wherein the data file comprises at least one text entry, each text entry comprising an alphabetical word and at least one character; store a copy of only the alphabetical word of each text entry in a second database; associate a unique reference code with the copy of the alphabetical word of each text entry in the second database; create a record of the associated unique reference code in the first database; associate the record of the associated unique reference code in the first database with the corresponding text entry of the data file maintained in the first database; and perform search of a search string entered by a user by using the copy of the alphabetical word of each text entry in the second database and to use the associated unique reference code in the second database and the record of the associated unique reference code in the first database to identify results of the search of the search string.

Each text entry in the first database may further comprise at least one non-alphabetical character.

The processor control code may further comprise code to store the copy of the alphabetical character in the second database in which said code is adapted to: apply an elimination code to a copy of each text entry in the first database to eliminate the at least one non-alphabetical character in each text entry so that only the at least one alphabetical character is remained in the copy of each text entry, and store the remained at least one alphabetical character from the copy of each text entry in the second database.

The processor control code further comprises code to perform the search of the search string in which said code is adapted to: store the search string entered by the user comprising at least one alphabetical character; compare the at least one alphabetical character in the search string with the copy of the at least one alphabetical character of each text entry in the second database, and if a match is found, identify the matched copy of the alphabetical word in the second database and use the second unique reference code associated with the matched copy of the alphabetical word in the second database and the associated first unique reference code in the first database to identify the associated text entry maintained by the data file in the first database, wherein the at least one alphabetical character in the search string can be found in the identified associated text entry.

The processor control code may further comprise code to perform the search the search of the search string in which said code is adapted to: store the search string entered by the user, the search string comprising at least one alphabetical character and at least one non-alphabetical character; compare only a copy of the at least one alphabetical character in the search string with the copy of the at least one alphabetical character of each text entry in the second database, if a match is found, identify the matched copy of the alphabetical character in the second database and using the second unique reference code associated with the matched alphabetical character in the second database and the associated first unique reference code in the first database to identify the associated text entry maintained by the data file in the first database, compare the at least one non-alphabetical character in the search string with the at least one non-alphabetical character of the identified associated text entry maintained by the data file in the first database, and if a match is found between the at least one non-alphabetical character in the search string and the at least one non-alphabetical character of the identified associated text entry, displaying the identified associated text entry in the first database as a result of the search of the search string.

The code may be adapted to apply an elimination code to a copy of the search string to eliminate the at least one non-alphabetical character from the copy of the search string, prior to comparing only the copy of the at least one alphabetical character in the search string.

The code may be adapted to convert each character in the search string to a lower case character prior to comparing the at least one alphabetical character in the search string with the copy of the alphabetical character of each text entry in the second database.

The search string may further comprise at least two alphabetical words which are sorted in an alphabetical order before being compared with the copy of the alphabetical word of each text entry in the second database.

The data file may be a log file. The unique reference code may be a hash code generated by a hash function.

### BRIEF DESCRIPTION OF THE DRAWINGS

These and other aspects of the invention will now be further described, by way of example only, with reference to the accompanying figures in which:

FIG. 1 illustrates a system for searching data file in a log file according to one embodiment of the invention;

FIG. 2 illustrates a log file structure stored in a first database; and

FIG. 3 illustrates a log file structure stored in a second database.

FIG. 4 illustrates a log file structure in the second database in which a unique reference code is associated with each data entry;

FIG. 5 illustrates a log file structure in the first database in which a record of the unique reference code is associated with each data entry; and

FIG. 6 illustrates a flow diagram of the search technique.

### DETAILED DESCRIPTION OF PREFERRED EMBODIMENTS

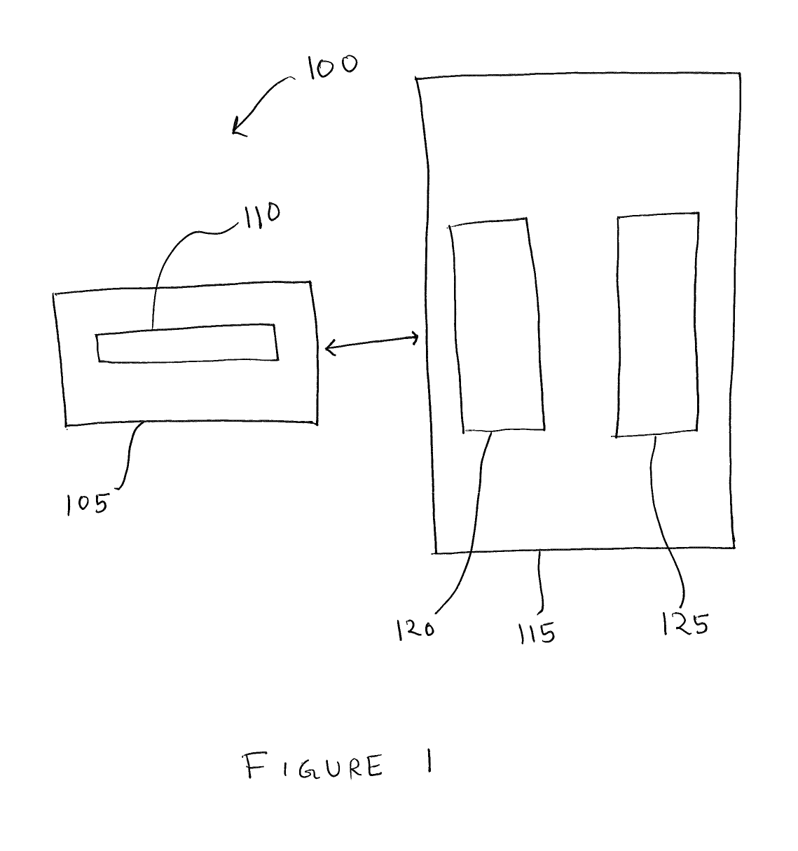

FIG. 1 illustrates a system 100 for searching a data file in a log file. The system 100 includes a computer system 105 in which an application 110 is capable of running. A user can enter a search string on the application 110. The computer system 105 is coupled to a server 115 which includes a first database 120 and a second database 125. The first database 120 is a log file database containing all the log files relevant to the system 100. The second database 125 is a database which is created to operate in association with the first database 120. The second database 125 can be termed as an “anomaly” database, as this database contains data derived from the data of the first log file database 120.

The first log file database 120 includes a plurality of log files. Each log file can include a plurality of data entry, each data entry can include at least two portions. A first portion of the data entry contains an alphabetical word and a second portion of the data entry can contain any one or more of digits, symbols and/or characters. In one example, the second portion refers to non-alphabetical characters. The server 115 is configured to apply an elimination code to a copy of each data entry stored in the log file of the first database 120. The elimination code then removes the second portion containing digits, symbols and/or characters from each copy of each data entry in the first database 120. In other words, the elimination code only retains the first portion containing the alphabetical word in each copy of each text entry. The server 115 then stores the remainder portion (alphabetical word) of each copy of each text entry into the second database 125. Therefore the second database 125 only contains data entries each having only alphabetical words.

The server 115 then creates a unique reference code for each data entry (including an alphabetical word) in the second database and then associates the unique reference code to each data entry in the second database.

The server then updates each unique reference code in the first database 120 and associates each record of the unique reference code in the first database with the corresponding original log file entry. In other words, the unique reference code associated with the data entry in the second database 125 is linked with the original data entry via the record of the unique reference codes in the first database 120. The unique reference code in the second database 125 and the record of the unique reference code in the first database 120 link a data entry in a log file with a corresponding data entry (including only alphabetical words) in the second database 125.

It will be appreciated that the unique reference code can be a hash code created by a hash generation function. In one example, the hash code can be an MD5 hash code, SH1 or a unique formula so as to provide accuracy.

A user can enter the search string including at least one alphabetical word in the application 110. The server 115 can then compare only the alphabetical word in the search string with the data entries in the second database 120. In this way, no initial search has taken place in the first database in which a log filed with huge data volume can be present.

If there is a match found between the alphabetical word in the search string and the data entries in the second database 125, the server 115 uses the unique reference code of each matched text entry in the second database 125 to locate the corresponding data entry in the first database 120 (by using the record of the unique reference code in the first database which links the original text entry in the first database to the corresponding data entry in the second database).

The server 115 then compares the entire search string (which may have alphabetical words and non-alphabetical characters) with the matched data entry in the first database 120, and particularly compares the non-alphabetical characters in the search string. If an entire match is found between the search string and the data entries in the first database identified by using the unique reference codes, the matched data entry is displayed in the application 110 in the system. This search technique is particularly advantageous as this does not require searching the all the entries in a log file

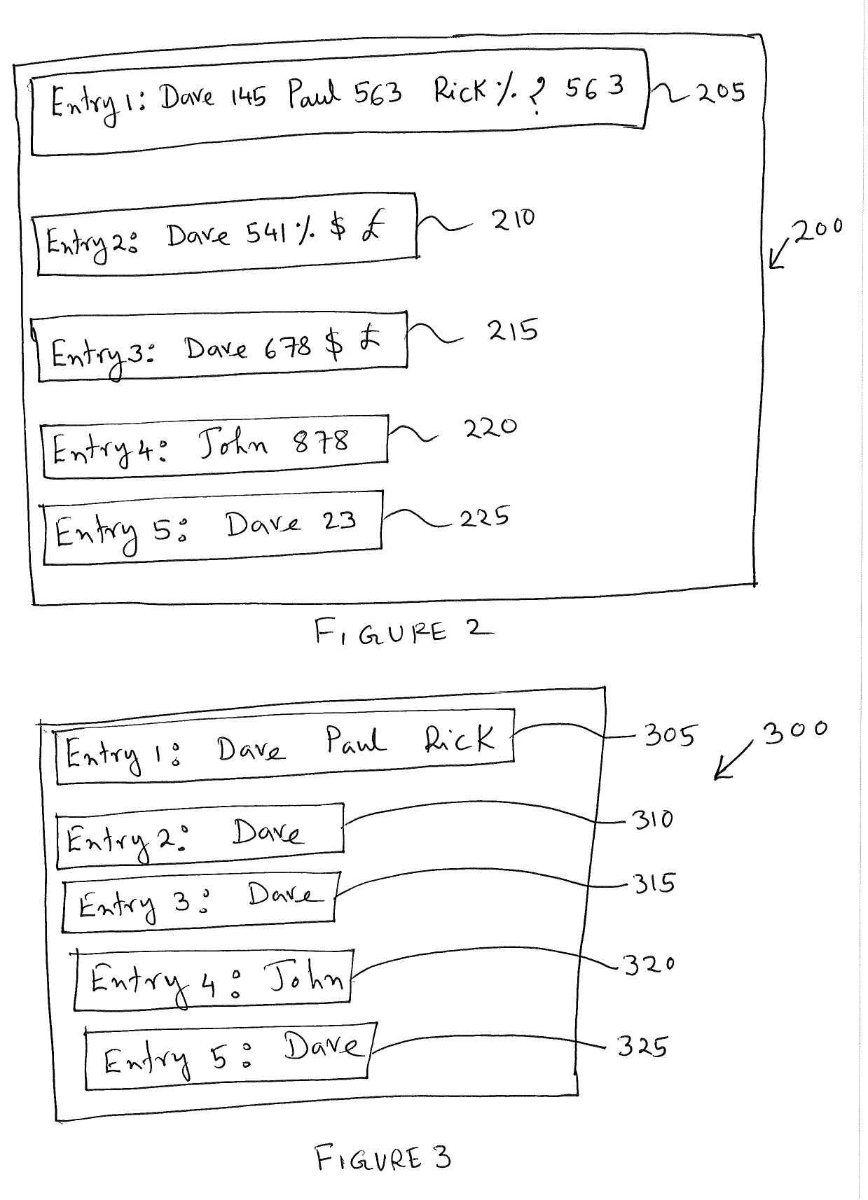

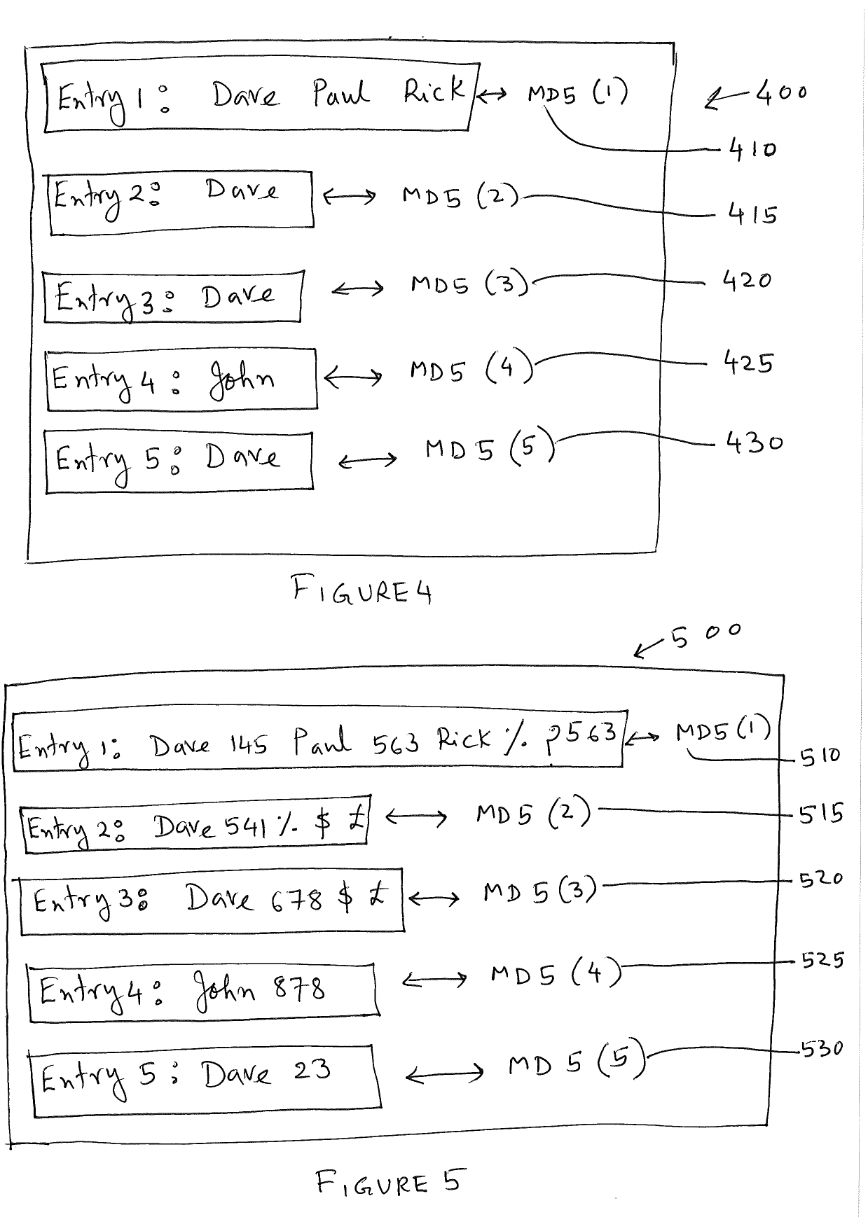

FIG. 2 illustrates a structure of a log file 200 stored in a log file database 120 of the system of FIG. 4. In this example, the log file 200 includes five data entries 205, 210. 215, 222, 225. Each data entry includes an alphabetical word portion and a non-alphabetical character portion. For example, in the second entry 210, the alphabetical word portion is ‘Dave’ and the non-alphabetical character portion is “541%$£”. The server 115 applies the elimination code to a copy of each data entry 205, 210, 215, 220, 225. The elimination code removes the non-alphabetical character portion from each copy of the data entry. It will be appreciated that the elimination code does not remove the non-alphabetical character portion of the actual data entries of the first database. It only operates on a ‘copy’ of each data entry, hence the actual entries remain in the first database 120.

After applying the elimination code and removing the non-alphabetical character portion from the copy of each data entry, the alphabetical word portion is saved in the second database 125. FIG. 3 illustrates the structure of a log file in the second database 300 in which data entries 305, 310, 315, 320, 425 include only the alphabetical portion.

FIG. 4 illustrates a structure of a log file 400 stored in the second database. In this embodiment, each data entry in the log file 400 is linked to a unique reference code 410, 415, 420, 425, 430. In this example, the unique reference code is an MD5 hash code.

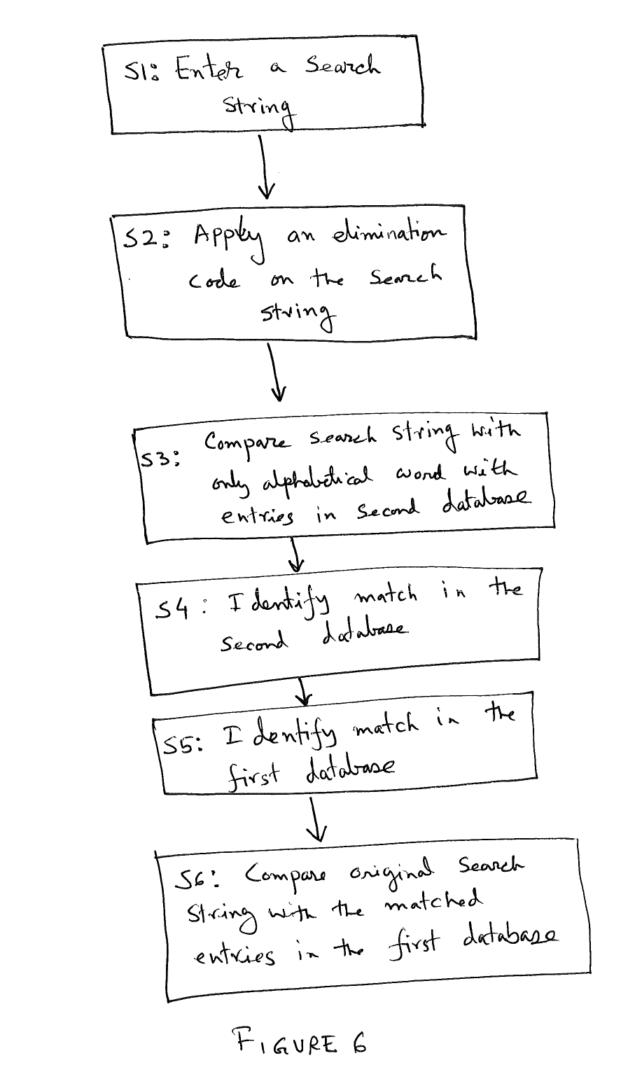

FIG. 5 illustrates a structure of a log file 500 stored in the first database. In this embodiment, each data entry in the log file 500 is linked to a second of a unique reference code used in the second database (of FIG. 4). For example, if the unique code MD5 (1) is linked to ‘Entry 1’ in the second database 400, then a record of MD5 (1) is created in the first database 500 and then is linked to “Entry 1” of the log file in the first database 120.

The unique reference code in the first database and the unique reference code in the second database are linked such that it is possible to link “entry 1” of the first database. It is thus determined that “Entry 1: Dave, Paul, Rick” in this second database is the alphabetical portion of the original data entry “Entry 1: Dave 145, Paul 563, Rick 1, ? 563” in the first database.

An example of the detailed steps of searching a search engine in the server 115 is described below and shown in FIG. 6.

S1: A user enters a search string “Dave 23” into the application 110. The application 110 is linked with the server 115.

S2: The server applies an elimination code on the search string “Dave 23” to remove the non-alphabetical character portion “23” and to keep only “Dave”. The server can then convert each letter of “Dave” as lower case. In a further embodiment, if the search engine had two alphabetical words, e.g. “Dave Apple”, the server would have sorted them in an alphabetical order, e.g. “Apple Dave”. These help to increase the search string.

S3: Compare the search string including only the alphabetical word with the data entries in the second database.

S4: If a match is found, identify the matched entry and then consequently identify the original data entry of the matched entry in the first database. The original data entry is identified using the link between the unique reference code in the second database and the corresponding record of the unique reference code in the first database.

S5: In the first database, four data entries are identified as the matched entries in the second database. These are:

(1) “Dave 145, Paul 563, Rick % ?563”

(2) “Dave 541% $ £”

(3) “Dave 678 $£”

(4) “Dave 23”

S6: Compare the original search string “Dave 23” with the four matched data entries above and then find the final matched entry as “Dave 23”.

It will be appreciated that the above embodiment shows only five data entries in each log file. However, in practice, a log file can have millions of entries. Searching through such a high volume of data entries would take a significant amount of time. When the alphabetical portion only is initially searched in the second database, a significant amount of data volume is already reduced and therefore takes a significantly shorter amount of time to the matched entries in the first database, and after that, when the entire search string (including both alphabetical words and characters) is compared to what is retrieved through using the unique reference codes in the first and second databases, it is only a very small amount of entries to compare and therefore the actual amount of time taken to complete the search is very short.

It will also be appreciated that the search string may not have any character portion and in that case all the search results would be based on the alphabetical word in the search string. It will be also appreciated that the each data entry in the log file can have only alphabetical characters but non non-alphabetical characters. In such a case, no elimination of the non-alphabetical characters are required. The alphabetical characters forming the alphabetical word can be directly saved to the second database.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A method of searching data in a data file in a storage device connected to a computer, the method comprising:
maintaining the data file in a first database in the storage device, wherein the data file comprises at least one text entry, each text entry comprising at least one alphabetical character, wherein a first unique reference code is associated with each text entry in the first database;
storing a copy of the at least one alphabetical character of each text entry in a second database in the storage device;
associating a second unique reference code with the copy of the at least one alphabetical character of each text entry in the second database;
updating each text entry in the first database by associating the first unique reference code used in the first database with the second unique reference code used in the second database, and
performing search of a search string entered by a user by using the copy of the at least one alphabetical character of each text entry in the second database and by using the second unique reference code in the second database and the first reference code in the first database to identify a text entry in the first database as a result of the search of the search string.

2. A method according to claim 1, wherein each text entry in the first database further comprise at least one non-alphabetical character.

3. A method according to claim 2, wherein the step of storing the copy of the alphabetical character in the second database comprises:
applying an elimination code to a copy of each text entry in the first database to eliminate the at least one non-alphabetical character in each text entry so that only the at least one alphabetical character is remained in the copy of each text entry, and
storing the remained at least one alphabetical character from the copy of each text entry in the second database.

4. A method according to claim 1, wherein the step of performing the search of the search string comprises:
storing the search string entered by the user comprising at least one alphabetical character;
comparing the at least one alphabetical character in the search string with the copy of the at least one alphabetical character of each text entry in the second database, and
if a match is found, identifying the matched copy of the alphabetical word in the second database and using the second unique reference code associated with the matched copy of the alphabetical word in the second database and the associated first unique reference code in the first database to identify the associated text entry maintained by the data file in the first database, wherein the at least one alphabetical character in the search string can be found in the identified associated text entry.

5. A method according to claim 1, wherein the step of performing the search of the search string comprises:
storing the search string entered by the user, the search string comprising at least one alphabetical character and at least one non-alphabetical character;
comparing only a copy of the at least one alphabetical character in the search string with the copy of the at least one alphabetical character of each text entry in the second database,
if a match is found, identifying the matched copy of the alphabetical character in the second database and using the second unique reference code associated with the matched alphabetical character in the second database and the associated first unique reference code in the first database to identify the associated text entry maintained by the data file in the first database,
comparing the at least one non-alphabetical character in the search string with the at least one non-alphabetical character of the identified associated text entry maintained by the data file in the first database, and
if a match is found between the at least one non-alphabetical character in the search string and the at least one non-alphabetical character of the identified associated text entry, displaying the identified associated text entry in the first database as a result of the search of the search string.

6. A method according to claim 5, further comprising:
prior to comparing only the copy of the at least one alphabetical character in the search string, applying an elimination code to a copy of the search string to eliminate the at least one non-alphabetical character from the copy of the search string.

7. A method according to claim 4, further comprising:
prior to comparing the at least one alphabetical character in the search string with the copy of the alphabetical character of each text entry in the second database, converting each character in the search string to a lower case character.

8. A method according to claim 4, wherein the search string further comprises at least two alphabetical words which are sorted in an alphabetical order before being compared with the copy of the alphabetical word of each text entry in the second database.

9. A method according to claim 1, wherein the data file is a log file.

10. A method according to claim 1, wherein the first and second unique reference codes are hash codes generated by a hash function.

11. A method according to claim 1, wherein the at least one non-alphabetical character is any one or more of a symbol, a sign and a digit.

12. A system for searching data in a data file, the system comprising a server comprising processor control code to:
to maintain the data file in a first database in the storage device, wherein the data file comprises at least one text entry, each text entry comprising at least one alphabetical character, wherein a first unique reference code is associated with each text entry in the first database;
to store a copy of the at least one alphabetical character of each text entry in a second database in the storage device;
to associate a second unique reference code with the copy of the at least one alphabetical character of each text entry in the second database;
to update each text entry in the first database by associating the first unique reference code used in the first database with the second unique reference code used in the second database, and
to perform search of a search string entered by a user by using the copy of the at least one alphabetical character of each text entry in the second database and by using the second unique reference code in the second database and the first reference code in the first database to identify a text entry in the first database as a result of the search of the search string.

13. A system according to claim 12, wherein each text entry in the first database further comprises at least one non-alphabetical character.

14. A system according to claim 13, wherein the processor control code further comprises code to store the copy of the alphabetical character in the second database in which said code is adapted to:
apply an elimination code to a copy of each text entry in the first database to eliminate the at least one non-alphabetical character in each text entry so that only the at least one alphabetical character is remained in the copy of each text entry, and
store the remained at least one alphabetical character from the copy of each text entry in the second database.

15. A system according to claim 12, wherein the processor control code further comprises code to perform the search of the search string in which said code is adapted to:
store the search string entered by the user comprising at least one alphabetical character;
compare the at least one alphabetical character in the search string with the copy of the at least one alphabetical character of each text entry in the second database, and
if a match is found, identify the matched copy of the alphabetical word in the second database and use the second unique reference code associated with the matched copy of the alphabetical word in the second database and the associated first unique reference code in the first database to identify the associated text entry maintained by the data file in the first database, wherein the at least one alphabetical character in the search string can be found in the identified associated text entry.

16. A system according to claim 12, wherein the processor control code further comprises code to perform the search of the search string in which said code is adapted to:
store the search string entered by the user, the search string comprising at least one alphabetical character and at least one non-alphabetical character;
compare only a copy of the at least one alphabetical character in the search string with the copy of the at least one alphabetical character of each text entry in the second database,
if a match is found, identify the matched copy of the alphabetical character in the second database and using the second unique reference code associated with the matched alphabetical character in the second database and the associated first unique reference code in the first database to identify the associated text entry maintained by the data file in the first database,
compare the at least one non-alphabetical character in the search string with the at least one non-alphabetical character of the identified associated text entry maintained by the data file in the first database, and
if a match is found between the at least one non-alphabetical character in the search string and the at least one non-alphabetical character of the identified associated text entry, displaying the identified associated text entry in the first database as a result of the search of the search string.

17. A system according to claim 16, wherein said code is adapted to apply an elimination code to a copy of the search string to eliminate the at least one non-alphabetical character from the copy of the search string, prior to comparing only the copy of the at least one alphabetical character in the search string.

18. A system according to claim 15, wherein said code is adapted to convert each character in the search string to a lower case character prior to comparing the at least one alphabetical character in the search string with the copy of the alphabetical character of each text entry in the second database.

19. A system according to claim 12, wherein the search string further comprises at least two alphabetical words which are sorted in an alphabetical order before being compared with the copy of the alphabetical word of each text entry in the second database.

20. A system according to claim 12, wherein the data file is a log file; and/or wherein the first and second unique reference codes are hash codes generated by a hash function.
